(19) United States
(12) Patent Application Publication
(10) Pub. No.: US 2011/0052126 A1
(43) Pub. Date: Mar. 3, 2011

(54) Optical Receptacle and Optical Module Using the Same

(75) Inventors: Takashi Yamamoto, Kitami-shi (JP); Michifumi Shouda, Kitami-shi (JP); Tomoyoshi Akashi, Kitami-shi (JP)

(73) Assignee: KYOCERA CORPORATION, Kyoto-shi, Kyoto (JP)

(21) Appl. No.: 12/935,268

(22) PCT Filed: Mar. 26, 2009
(86) PCT No.: PCT/JP2009/056165

§ 371 Date: Nov. 15, 2010

(30) Foreign Application Priority Data
Mar. 31, 2008 (JP) 2008-091423
Jul. 29, 2008 (JP) 2008-194978
Nov. 27, 2008 (JP) 2008-302302

(51) Int. Cl. G02B 6/42; G02B 6/36

(52) U.S. Cl. 385/92

(57) ABSTRACT

The present invention is to provide an optical receptacle which is resistant to a mechanical impact, to be capable of obtaining an excellent optical connection. The optical receptacle 1 includes a case 5 having an insertion hole 20 into which a plug ferrule 3 is to be inserted for holding an optical fiber 6, and a transparent substrate 15 disposed on a bottom surface 20a of the insertion hole 20 of the case 5. Further, the case 5 has a through hole 19 formed so as to penetrate from the bottom surface 20a of the insertion hole 20 to one edge face 5a of the case 5 and communicated with the insertion hole 20m, the through hole 19 having a diameter smaller than that of the insertion hole 20. The transparent substrate 15 is disposed in contact with the bottom surface 20a so as to cover the opening of the through hole 19 which opens in the bottom surface 20a of the case 5.

### BACKGROUND OF THE INVENTION

1. Field of the Invention

The present invention relates to an optical receptacle and an optical module which are used for optical communication, optical information processing, an optical sensor, and the like.

2. Description of the Related Art

Conventionally, a receptacle type optical module 104 as shown in FIG. 17 in which a package 112 accommodating a photon-electron or electron-photon conversion element 102 therein is disposed at one end of an optical receptacle 100 (on the right side in the drawing), and a plug ferrule 103 is connected to the other end of the optical receptacle 100, to transmit or receive an optical signal, has been provided as an optical module (refer to, for example, JP 2003-075679A).

This optical receptacle 100 includes a fiber stub 107 composed of a ferrule 105 and an optical fiber 106 inserted in a hole of the ferrule 105. The rear end part of the fiber stub 107 is pressed to be fixed into a holder 108. The front end part of the fiber stub 107 is inserted into an inner hole of a sleeve 109.

The plug ferrule 103 is inserted into the sleeve 109 from the side of the front end part of the optical receptacle 100 configured in this way, and an edge face of the optical fiber 106 in the fiber stub 107 and an edge face of the optical fiber 106 on the side of the plug ferrule 103 are brought into contact with each other, to exchange an optical signal.

Meanwhile, the shape of the light-emitting device using the optical module 104 is standardized. However, as a modulation rate of an electrical signal applied to the photon-electron or electron-photon conversion element 102 is speeded up, an electrical circuit required for driving the photon-electron or electron-photon conversion element 102 tends to be larger in size. It is required to shorten the optical receptacle 100 in order to bring the optical module 104 into a given size.

However, it is not easy to shorten the optical module 104 using the fiber stub 107.

Then, an optical receptacle in which the fiber stub 107 is omitted, and the photon-electron or electron-photon conversion element 102 and the plug ferrule 103 are optically connected via a light-transmissive plate-like body in place of the fiber stub 107 has been proposed (refer to, for example, JP-2005-242314A).

In this optical receptacle, the outer circumferential surface of the plate-like body is made to adhere to the inner side of a through hole formed in the holder 108, to block the through hole in the holder 108. Then, the front end of the plug ferrule 103 is contacted with the plate-like body, and the ferrule 103 is placed in the correct position.

However, in the case where the plug ferrule 103 is repeatedly inserted and pulled out, or in the case where the optical receptacle is used for a long period in a high-temperature and humid circumstance, the problem that the plate-like body drops off from the holder 108 may occur.

### SUMMARY OF THE INVENTION

The present invention has been achieved in consideration of the above-described circumstances. An object of the present invention is to provide a short-type optical receptacle and a short-type optical module which are resistant to a mechanical impact, to be capable of obtaining a suitable optical connection.

An optical receptacle according to an aspect of the present invention, the optical receptacle to which a plug ferrule for holding an optical fiber is connected, includes a case forming an outer shell, the case having an insertion hole which has a bottom surface at one end thereof and into which the plug ferrule is inserted, and a transparent substrate disposed on the bottom surface. The case has a through hole formed so as to penetrate from the bottom surface of the insertion hole to an end face of the case. The through hole having a diameter smaller than that of the insertion hole and the through hole is communicated with the insertion hole. The transparent substrate is in contact with the bottom surface of the case so as to cover an opening of the through hole which opens in the bottom surface of the case.

An optical module according to another aspect of the present invention includes the optical receptacle, an optical element for receiving or emitting a light passing through the through hole, and a cylindrical body joined to the case of the optical receptacle to accommodate the optical element.

### BRIEF DESCRIPTION OF THE DRAWINGS

FIG. 1 is a cross-sectional view showing an optical receptacle according to an embodiment of the present invention.

FIG. 2 is a cross-sectional view showing an optical receptacle and an optical module according to an embodiment of the present invention.

FIG. 3A, FIG. 3B, FIG. 3C and FIG. 3D are plan views showing each shape of a transparent substrate.

FIG. 4 is a graph showing changes of the contacting areas between a transparent substrate and a sleeve relative to the diameter of the transparent substrate.

FIG. 5A and FIG. 5B are plan views for explaining a method for processing a transparent substrate.

FIG. 6 is a schematic view for explaining a method for processing a circular transparent substrate.

FIG. 7A is a cross-sectional view showing an optical receptacle according to an embodiment of the present invention, and FIG. 7B is an enlarged sectional view of a part of the FIG. 7A.

FIG. 8A is a cross-sectional view showing an optical receptacle according to an embodiment of the present invention, and FIG. 8B is an enlarged sectional view of a part of the FIG. 8A.

FIG. 9A, FIG. 9B and FIG. 9C are perspective views showing an example of the shape of a transparent substrate used in the optical receptacle according to an embodiment of the present invention.

FIG. 10A and FIG. 10B are plan views showing an example of the method for producing the transparent substrate.

FIG. 11A and FIG. 11B are plan views showing another example of the method for producing the transparent substrate.

FIG. 12A is a plan view showing still another example of the method for producing the transparent substrate, and

FIG. 12B is a sectional view of a part of the FIG. 12A.

FIG. 13 is a cross-sectional view showing an optical receptacle and an optical module according to an embodiment of the present invention.

FIG. 14 is a cross-sectional view showing an optical receptacle and an optical module according to an embodiment of the present invention.

FIG. 15 is a cross-sectional view showing an optical receptacle and an optical module according to an embodiment of the present invention.

FIG. 16 is a cross-sectional view showing an optical receptacle and an optical module according to an embodiment of the present invention.

FIG. 17 is a cross-sectional view showing an example of a conventional optical receptacle and an optical module using the same.

### DETAILED DESCRIPTION OF THE INVENTION

An optical receptacle according to the present invention will be described in detail below with reference to the accompanying drawings. However, the following respective examples of the embodiments are merely exemplified as the present invention, and the present invention is not limited thereto. In addition, in the respective drawings, common portions, components, and members are denoted by the same reference numerals, and overlapping descriptions will be omitted. The terms “the left, right, top and bottom” used for the descriptions are merely used for explanation of the positional relationships on the drawings. These do not mean the positional relationships in actual use.

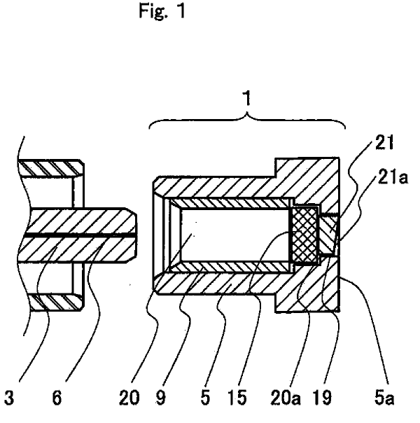

FIG. 1 shows an optical receptacle 1 according to an embodiment of the present invention. The optical receptacle 1 is provided with a case 5 having an insertion hole 20 into which a plug ferrule 3 is inserted, and a transparent substrate 15 disposed on a bottom surface 20a of the insertion hole 20. Further, the case 5 has a through hole 19 communicated with the insertion hole 20 from the bottom surface 20a of the case 5 to an end face 5a of the case 5. The through hole 19 is smaller in diameter than the insertion hole 20. The transparent substrate 15 disposed on the bottom surface 20a is disposed in contact with the bottom surface 20a so as to cover the opening of the through hole 19 which is open in the bottom surface 20a. Then, in the optical receptacle 1, the plug ferrule 3 for holding an optical fiber 6 is inserted into the insertion hole 20 so as to contact the transparent substrate 15.

In some cases, a sleeve 9 is disposed inside the insertion hole 20. In this case, it is preferable that the sleeve 9 is disposed so as to the rear edge face of the sleeve 9 contacts the transparent substrate 15. The sleeve 9 has a function to keep stop the plug ferrule 3. In addition, in the case where the sleeve 9 is not disposed, the plug ferrule 3 is inserted into the insertion hole 20.

The insertion hole 20 is blocked on its end face 5a side by the bottom surface 20a. The through hole 19 is provided in the bottom surface 20a so as to be communicated with the insertion hole 20. The other side of the insertion hole 20 is open to the outside of the case 5. As the hollow insertion hole 20 and the through hole 19 communicated with the insertion hole 20 are arranged to be aligned in the case 5, the case 5 forms a tubular form as a whole. In addition, light optically connected to the optical fiber 6 held in the plug ferrule 3 is propagated through the through hole 19 provided in the bottom surface 20a.

The transparent substrate 15 is transmissive for light emitted from the optical fiber 6 or light incident from the through hole 19, and has a function to position the plug ferrule 3 such that the transparent substrate 15 is brought into contact with the front end of the plug ferrule 3 to locate the front end of the plug ferrule 3 at a predetermined position. The transparent substrate 15 is disposed in contact with the bottom surface 20a of the insertion hole 20. The transparent substrate 15 may be fixed at the bottom surface 20a of the holder 5 with an adhesive or the like. As shown in FIG. 1, a hollow hole may be further processed in the bottom surface 20a, and the transparent substrate 15 may be disposed so as to be fit into this hollow hole.

The transparent substrate 15 is disposed in contact with the bottom surface 20a of the insertion hole 20. Even when the front end of the plug ferrule 3 is inserted into the insertion hole 20 so as to be brought into contact with the transparent substrate 15, and the plug ferrule 3 applies force to the transparent substrate 15, the transparent substrate 15 does not easily drop off, since the transparent substrate 15 is supported by the bottom surface 20a. Further, since the transparent substrate 15 is supported by the bottom surface 20a, positional deviation of the transparent substrate 15 is hardly caused, which makes it possible to maintain the optical characteristics.

In addition, the inside of the through hole 19 may be filled with a refractive index matching agent 21. The refractive index matching agent 21 is disposed so as to contact the transparent substrate 15, and has a refractive index comparable with the refractive index of the transparent substrate 15. When the refractive index of the transparent substrate 15 and the refractive index of the refractive index matching agent 21 are matched to be comparable with each other, it is possible to inhibit refraction and reflection of light between the transparent substrate 15 and the refractive index matching agent 21. It is preferable that the edge face 21a of the refractive index matching agent 21 on the side of the end face 5a is inclined to a plane perpendicular to the axial direction of the through hole 19. With the inclined surface, it is possible to reduce light reflected on the edge face of the refractive index matching agent 21 to return in the reverse direction.

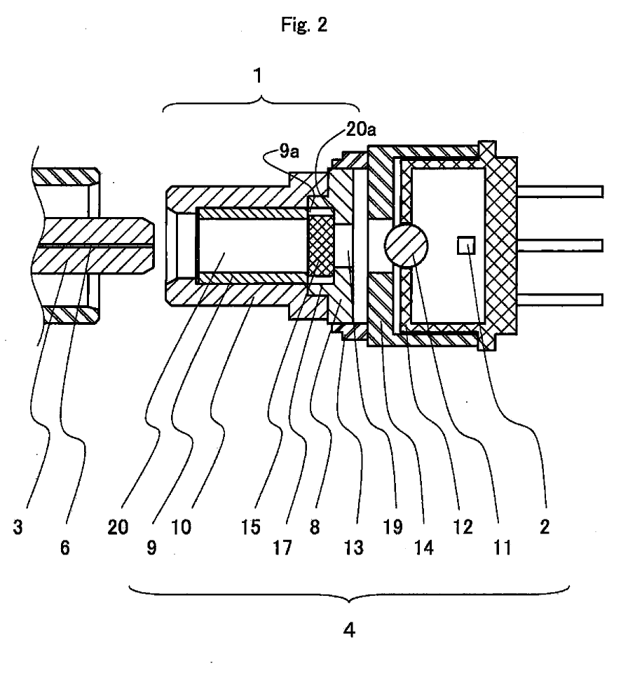

FIG. 2 is a cross-sectional view showing the optical receptacle 1 and an optical module 4 including the optical receptacle 1 according to another embodiment of the present invention.

In the optical receptacle 1 according to the present embodiment, the case 5 is composed of a holder 8 and a shell 10. Then, the insertion hole 20 is composed of a hole passing through the shell 10 and a hole 17 provided in the holder 8. Further, the through hole 19 passing from the bottom surface 20a of the insertion hole 20 to the surface on the opposite side of the bottom surface 20a is provided so as to be communicated with the insertion hole 20. The transparent substrate 15 is disposed on the bottom surface 20a so as to be brought into contact with the bottom surface 20a to cover the through hole 19.

The holder 8 has a tubular form as a whole, with the through hole 19 with a diameter smaller than the diameter of the hole 17 partially forming the insertion hole 20. In addition, the through hole 19 is provided for optical connection between the photon-electron or electron-phton conversion element 2 in the package 12 and the optical fiber 6 held by the plug ferrule 3, and for passing through a signal light through the through hole 19.

The tubular sleeve 9 is held inside the shell 10. The plug ferrule 3 for holding the optical fiber 6 is inserted into the sleeve 9. Then, the transparent substrate 15 is disposed so as to be held between the bottom surface 20a of the insertion hole 20 and a rear edge face 9a of the sleeve 9. Accordingly the transparent substrate 15 is held inside the optical receptacle 1, and the transparent substrate 15 hardly drops off.

That is, in the optical receptacle 1 of the present embodiment, the transparent substrate 15 is pressed against the bottom surface 20a of the through hole 20 by inserting the plug ferrule 3 into the optical receptacle 1. And the front end position of the plug ferrule 3 brought into contact with the transparent substrate 15 is usually disposed at a constant position. Accordingly, the front end position of the optical fiber 6 is always kept at a constant position even when the plug ferrule 3 is repeatedly inserted and pulled out. In addition, the transparent substrate 15 is held between the bottom surface 20a and the rear edge face 9a of the sleeve 9, thereby the transparent substrate 15 hardly drops off from the holder 8. In the case where an adhesive is not used for fixation of the transparent substrate 15, even in the case where the optical receptacle is used for a long period in a high-temperature and humid environment, there is no positional deviation of the transparent substrate 15 due to an adhesive expanding or contracting by a temperature change or an adhesive absorbing moisture to have swelling.

When the plug ferrule 3 is inserted, the transparent substrate 15 is pressed against the bottom surface 20a of the insertion hole 20. Accordingly, when the bottom surface 20a is set perpendicular to the insertion direction of the plug ferrule 3, it is easy to set the transparent substrate 15 perpendicular to the insertion direction of the plug ferrule 3. Thereby, it is possible to make a good physical contact between the optical fiber 6 and the transparent substrate 15, which makes it possible to reduce deterioration of a signal light.

In addition, the front end of the plug ferrule 3 inserted into the optical receptacle 1 is mirror polished so as to have a curved surface with a radius of curvature of 5 to 30 mm in order to facilitate the physical contact, and the edge face of the optical fiber 6 disposed in the center of the plug ferrule 3 is disposed in the vicinity of the foremost end part of the plug ferrule 3. The edge face of the optical fiber 6 physically contacts the transparent substrate 15 by inserting the plug ferrule 3 into the optical receptacle 1. It is desirable that the transparent substrate 15 is a parallel plate in order to get the optical fiber 6 in the plug ferrule 3 in good contact with the transparent substrate 15.

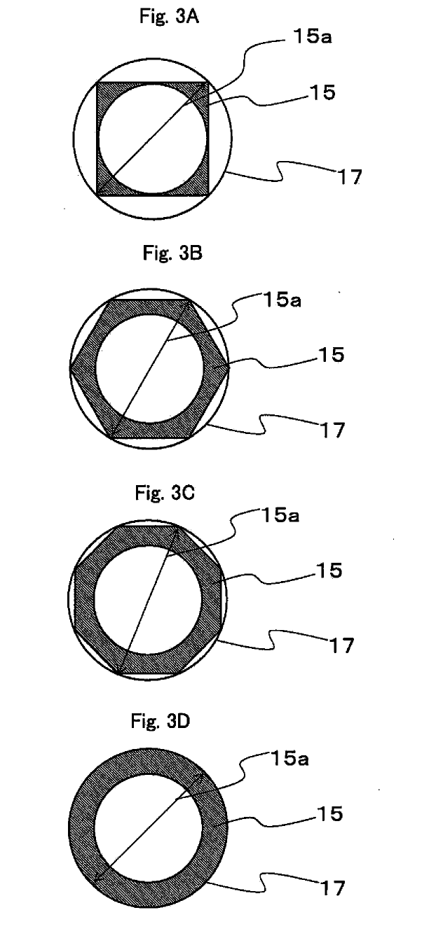

It is preferable that the transparent substrate 15 has different shape from a generally used tetragonal shape, such as a hexagonal shape shown in FIG. 3B or an octagonal shape sown in FIG. 3C, or a discoid shape shown in FIG. 3D. In addition, among the transparent substrates 15 shown in the respective drawings of FIGS. 3B, 3C, and 3D, it is preferable that, in the case where the transparent substrate 15 has a polygonal shape such as a hexagonal shape or an octagonal shape, its diagonal line length 15a and the diameter of the hole 17 are set to be substantially equal. Further, it is preferable that, in the case where the transparent substrate 15 is a circular shape, its diameter 15a and the diameter of the hole 17 are substantially equal. In this way, the transparent substrate 15 is disposed so as to internally touch the inside of the hole 17, thereby making the transparent substrate 15 hardly move in the radial direction in the hole 17.

Moreover, the diameter of the inscribing circle of the transparent substrate 15 is set to be longer than the diameter of the through hole 19 and the inside diameter of the sleeve 19. In the case where the transparent substrate 15 is a circular shape, the diameter of the transparent substrate 15 is set to be longer than the diameter of the through hole 19 and the inside diameter of the sleeve 19.

In the case where a vibration or an impact is applied to the optical receptacle 1, the transparent substrate 15 is hit against the bottom surface 20a of the holder 8 and the rear edge face 9a of the sleeve 9, which may cause defects such as cracks or chips. The corner portions of the transparent substrate 15 on the side of the sleeve 9 tends to be easily defective.

The hatchings of the transparent substrates 15 in FIGS. 3A, 3B, 3C, and 3D indicate the portions on which the surface of the transparent substrate 15 and the rear edge face of the sleeve 9 are in contact with each other. Herein, in the case where the transparent substrate 15 is formed into a conventional tetragonal shape as shown in FIG. 3A, the area in contact with the sleeve 9 is narrower, as the number of corners is less. Therefore, stress is concentrated on the corners of the transparent substrate 15. In contrast thereto, the transparent substrate 15 of the present embodiment shown in FIGS. 3B, 3C, and 3D has a hexagonal shape, an octagonal shape, or a circular shape, and the numbers of the corners are many, and those corners are provided with obtuse angles greater than the right angle, and the contacting areas with the rear edge face 9a of the sleeve 9 is possibly greater. Therefore, stress applied on the transparent substrate 15 is dispersed, which makes it hardly crack or chip.

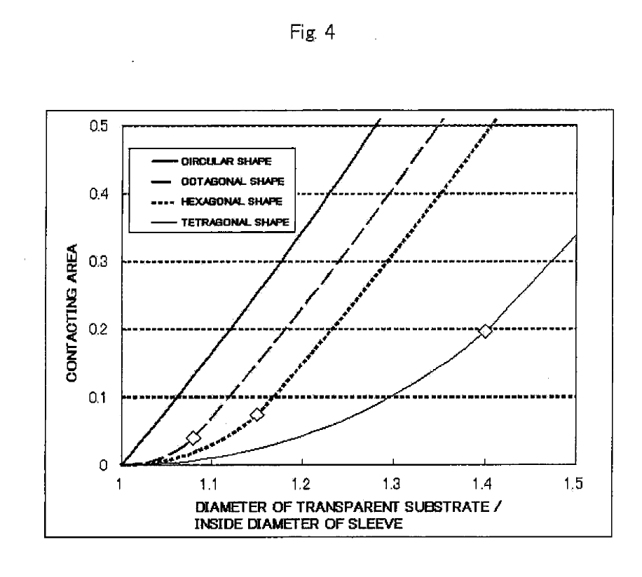

FIG. 4 is a graph showing changes of the contacting areas between the transparent substrate 15 and the sleeve 9. In FIG. 4, the diameters of the transparent substrate 15, or, the ratios that the diagonal line lengths 15a or the diameters 15a of the transparent substrates 15 are divided by the inside diameter of the sleeve 9 are plotted on the abscissa axis, and the contacting areas between the transparent substrate 15 and the sleeve 9 are plotted on the ordinate axis. In addition, the diameters of the transparent substrate 15 are normalized with respect to the inside diameter of the sleeve 9. For example, when the normalized value is 1, the diameter of the transparent substrate 15 is meant to be equal to the inside diameter of the sleeve 9. Further, it is assumed that the respective shapes of the transparent substrate 15 have all regular polygonal shapes.

As shown in FIG. 4, it is shown that, in the case where the transparent substrate 15 has a tetragonal shape, the level of stress concentration is higher, because its contacting area is smaller than those of the other shapes. In contrast thereto, in the cases where the transparent substrates 15 have a hexagonal shape, an octagonal shape, and a circular shape, their contacting areas are increased, and the levels of stress concentration are lowered accordingly. In addition, even in the case where the transparent substrate 15 is formed into a tetragonal shape, by making the transparent substrate 15 larger in size, its contacting area with the sleeve 9 is increased accordingly, which relieves the stress concentration. However, in this case, the diagonal line length 15a of the transparent substrate 15 would be too large. Consequently, it is necessary to increase the diameter of the hole 17 into which the transparent substrate 15 is inserted according to the increase of the diagonal line length 15a. However, since the optical receptacle 1 is required to be further downsized, it is not easy to enlarge the diameter of the hole 17.

When the diameter of the circle circumscribing the transparent substrate 15 (i.e., the inside diameter of the hole 17) is set sufficiently longer than the inside diameter of the sleeve 9, the contacting portion between the transparent substrate 15 and the sleeve 9 forms a ring shape with a substantially constant width which is seamless in its circumferential direction. In the case where the entire outer circumference of the transparent substrate 15 contacts the ring shape, stress is not concentrated on the corner portions of the transparent substrate 15 in any case, which does not cause cracks or chips. In addition, in the case where the transparent substrate 15 has a polygonal shape such as a hexagonal shape or an octagonal shape, the diameter of the inscribing circle of the transparent substrates 15 is substantially equal to the distance between the distance of the opposite sides thereof, and as the extreme case where the transparent substrate 15 is a circular shape, the diameter of the inscribing circle of the transparent substrates 15 becomes equal to the diameter of the circular shape. As explained herein, in the case where the shape of the transparent substrate 15 having a hexagonal shape, an octagonal shape, or a circular shape, the contacting portion between the transparent substrate 15 and the sleeve 9 forms a ring shape which is seamless in its entire circumference and the transparent substrate 15 does not have to be large in size.

This will be again described with reference to FIG. 4. Places at which the rates of increase of the contacting areas is changed in the respective shapes of the transparent substrates 15 are shown in FIG. 4 (the place is indicated by the rhombuses in the graph). The shape of the contacting portion between the transparent substrate 15 and the sleeve 9 will form a seamless ring shape, when the transparent substrate is larger than the places. When the shape of the transparent substrate 15 is a circular shape, the contacting portion between the transparent substrate 15 and the sleeve 9 is naturally a ring shape which is always seamless, and therefore no rhombuses mark is shown. As shown herein, in the case when the transparent substrate 15 is a tetragonal shape, the contacting portion forms a seamless ring shape only after the diameter of the hole 17 provided in the holder 8 becomes 1.4 times as long as the inside diameter of the sleeve 9. In contrast thereto, in the cases where the transparent substrates 15 having a hexagonal shape, an octagonal shape, and a circular shape, their shape of contacting portions that form seamless ring shapes are before the diameter of the hole 17 formed in the holder 8 becomes 1.2 times as long as the inside diameter of the sleeve 9.

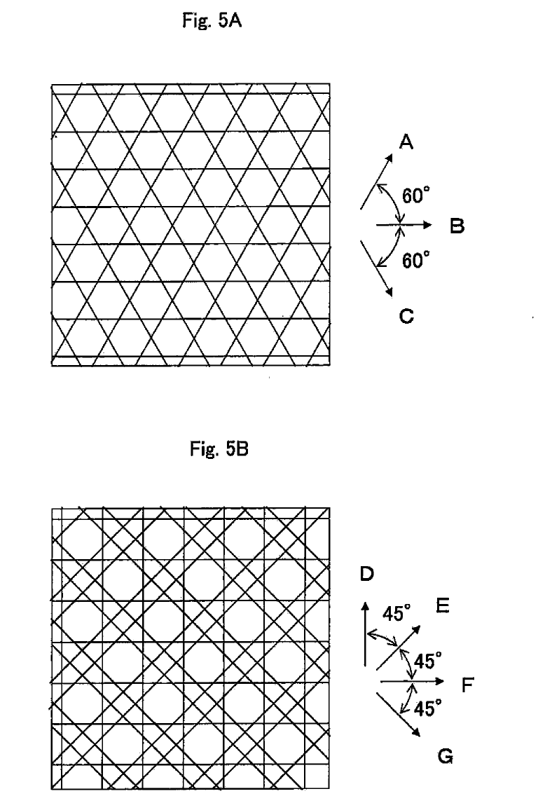

The transparent substrate 15 which has a polygonal shape may be obtained by segmentalizing a large-sized parallel planar substrate with a thickness equal to that of the transparent substrate 15 by a cutting work such as dicing or the like. FIG. 5A shows a dicing pattern for obtaining a hexagonal-shaped transparent substrate 15, and FIG. 5B shows a dicing pattern for obtaining an octagonal-shaped transparent substrate 15. In the case where the transparent substrate 15 has a hexagonal shape, a large-sized parallel planar substrate is segmentalized by cutting in three directions at an angle of 60 degrees to each other shown by A, B, and C in FIG. 5A. In the case where the transparent substrate 15 has an octagonal shape, a large-sized parallel planar substrate is segmentalized by cutting in four directions at an angle of 45 degrees to each other shown by D, E, F, and G in FIG. 5B. As described here, when the transparent substrate 15 is formed into an even-ordered polygonal shape such as a hexagonal shape or an octagonal shape, the processing is easier as the opposed sides facing each other (opposite sides) are respectively parallel to each other.

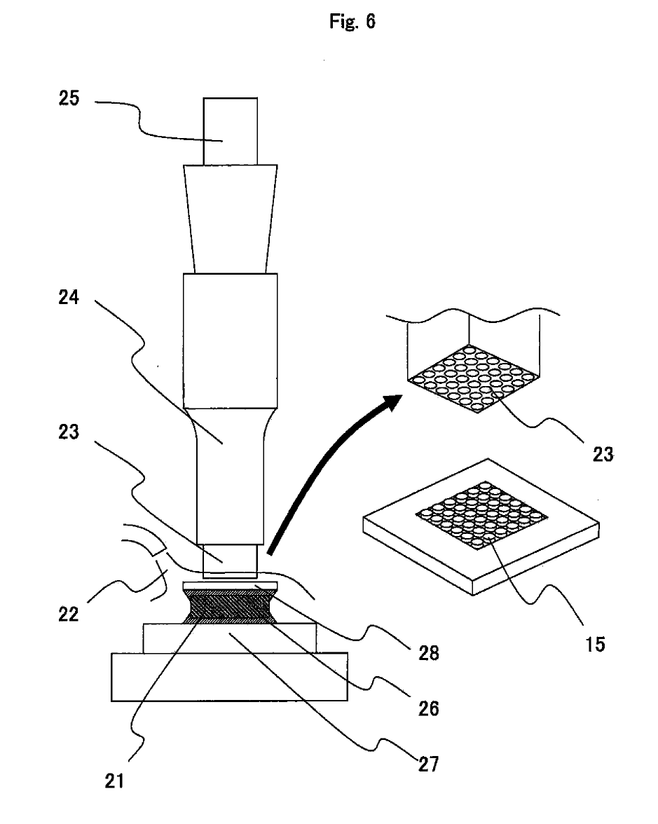

The circular transparent substrate 15 is obtained by segmentalizing the substrate by ultrasonic machining using free abrasive grains. The ultrasonic machining is shown in FIG. 6. The ultrasonic machining is a technique that a working fluid 22 in which abrasive grains are mixed into a solvent such as oil or water is added between a tool 23 vibrating vertically in ultrasonic frequency and a processing object. The tool 23 is pressed against the processing object with appropriate pressure force, then crushing the object by an impact of the abrasive grains, and the shape of the tool 23 is transcribed onto the processing object. An ultrasonic-vibrator 25 is built into the tool 23 via a joint called a horn 24. Stainless steel, hard steel, hardened steel, or the like is used for the tool 23 as a material thereof. Further, carborundum, boron carbide, silicon carbide, or the like is used as abrasive grains.

As described above, in the case where the transparent substrate 15 has a polygonal shape such as a hexagonal shape or an octagonal shape which has the number of vertex more than five (pentagonal shape) and particularly an even-ordered polygonal shape, or has a circular shape, the contacting area with the sleeve 9 can be sufficiently large enough to lower the level of concentration of stress, even in the case where there is a limit in the size of the transparent substrate 15. And therefore, this makes it possible to provide the optical receptacle 1 resistant to a vibration or an impact in the optical receptacle 1. Further, even in the case where the contacting portion with the sleeve 9 is formed into a seamless ring shape in order to prevent damage to the transparent substrate 15, the transparent substrate 15 can be formed relatively small in size, which may contribute to downsizing of the optical receptacle 1 and the optical module 4.

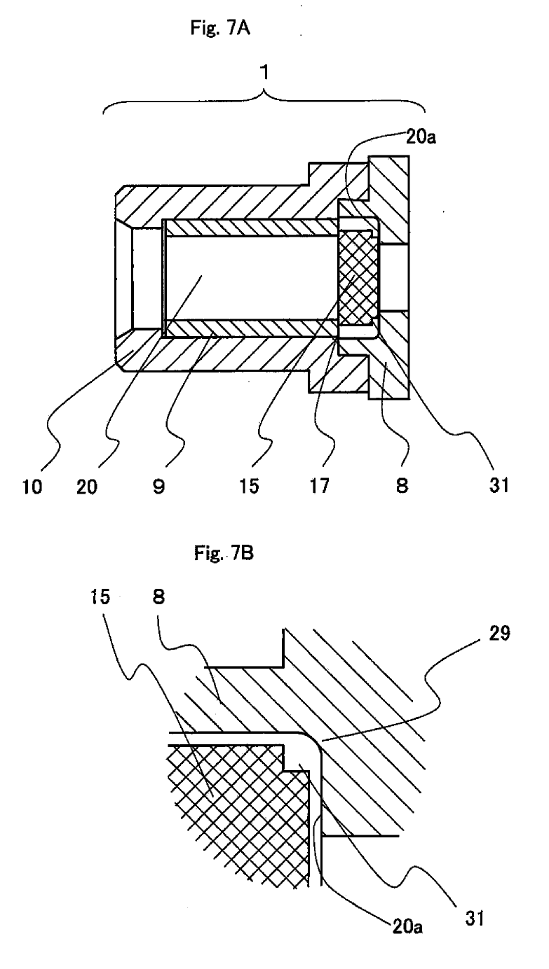

FIG. 7A is a cross-sectional view showing the optical receptacle 1 according to another embodiment of the present invention, and FIG. 7B is an enlarged sectional view of a part of FIG. 7A. The optical receptacle 1 has the shell 10 and the transparent substrate 15 formed into a polygonal shape and disposed inside the insertion hole 20 provided in the holder 8. The optical receptacle 1 according to the present embodiment is the same as the optical receptacle 1 of the embodiment shown in FIG. 2 except for chamfered portions 31 which are formed onto the corner portions of a contacting surface of the transparent substrate 15, the contacting surface being in contact with the bottom surface 20a of the insertion hole 20. Because the difference of the present embodiment is at the chamfered portion 31 for the embodiment shown in FIG. 2, the descriptions common to the embodiment of FIG. 2 thereof will be omitted.

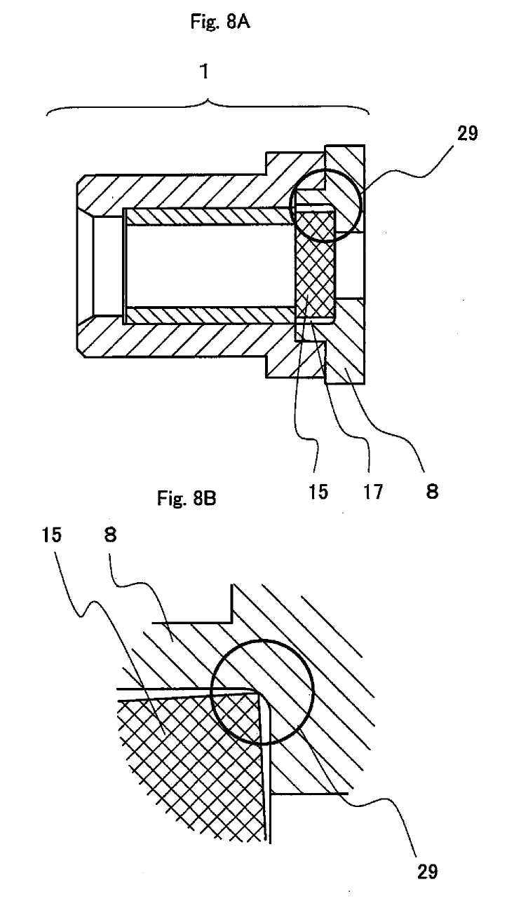

As shown previously, in the case where a vibration or an impact is applied to the optical receptacle 1, the transparent substrate 15 may violently crash against the bottom surface 20a or the sleeve 9. As shown in FIGS. 8A and 8B, in the case where there is a chamfered plane area or rounded plane area 29 on the outer circumferential portion of the bottom surface 20a of the insertion hole 20, the corners of the outer circumferential sides of the transparent substrate 15 may touch the chamfered plane area or rounded plane area 29, and stress is concentrated on the corner portions of the transparent substrate 15, that tends to cause defects therein. The chamfered plane area or rounded plane area can be brought about in the holder because the corner portion of a drilling machine or an end mill is not always at a right angle. When the chamfered portions 31 are formed onto the corner portions of the transparent substrate 15, gaps are provided between the corner portions of the transparent substrate 15 and the inner surface of the insertion hole 20 as shown in FIGS. 7A and 7B, thus the transparent substrate 15 does not contact the chamfered plane area or rounded plane area 29 created on the outer circumferential portion of the bottom surface 20a, which avoid concentration of stress, that may cause little cracks or chips.

The transparent substrate 15 is pressed against the bottom surface 20a of the hole 17 provided in the holder B when the plug ferrule 3 is inserted into the optical receptacle 1. However, in the case where the transparent substrate 15 is riding on the chamfered plane area or rounded plane area 29 as shown in FIG. 8B, the transparent substrate 15 may be inclined to the insertion direction of the plug ferrule 3 in some cases Herein, the plug ferrule 3 to be inserted into the optical receptacle 1 is, as described above, subject to mirror polishing on its front edge face to be a curved surface, and the edge face of the optical fiber 6 disposed in the center of the plug ferrule 3 is disposed in the vicinity of the foremost end part of the plug ferrule 3.

When the transparent substrate 15 is inclined to the insertion direction of the plug ferrule 3, the physical contact (PC) between the transparent substrate 15 and the optical fiber 6 becomes unstable, which may caused by a gap between the transparent substrate 15 and the optical fiber 6, to bring about a light reflection in some cases. In contrast thereto, when the chamfered portions 31 are formed onto the corner portions of the transparent substrate 15 as shown in FIGS. 7A and 7B, the transparent substrate 15 does not run on the chamfered plane area or rounded plane area 29 created on the outer circumferential portion of the bottom surface 20 in any case, and is disposed so as to be perpendicular to the insertion direction of the plug ferrule 3. Therefore, a stable physical contact between the transparent substrate 15 and the optical fiber 6 is possibly obtained.

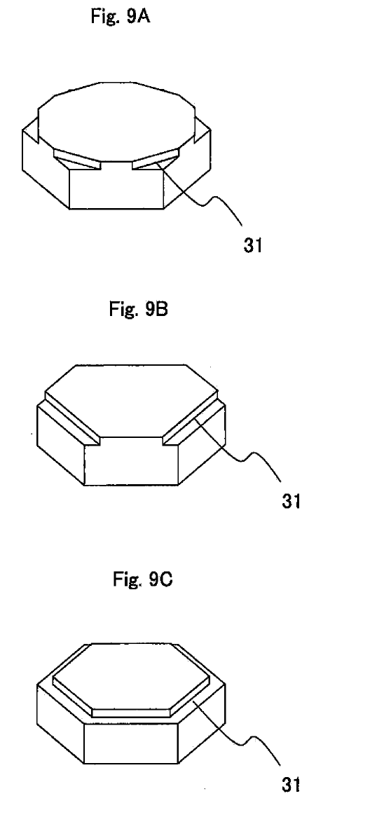

As shapes of the chamfered portions 31 onto the corner portions of the transparent substrate 15, FIG. 9 are perspective views showing the examples of various shapes of the chamfered portions 31. Herein, the hexagonal shape is shown as a shape of the transparent substrate 15. However, it is possible to apply the same chamfered portions 31 onto an octagonal shape and other shapes as well.

Herein, in FIG. 9A, the chamfered portions 31 are formed only onto the corner portions of the transparent substrate 15. In FIG. 9B, the chamfered portions 31 are formed along the side of the transparent substrate 15 onto one of two adjacent sides so that chamfered sides of the chamfered portions 31 and non-chamfered sides are arranged alternately. Moreover, in FIG. 9C, the chamfered portions 31 are formed onto an entire circumference of the transparent substrate 15.

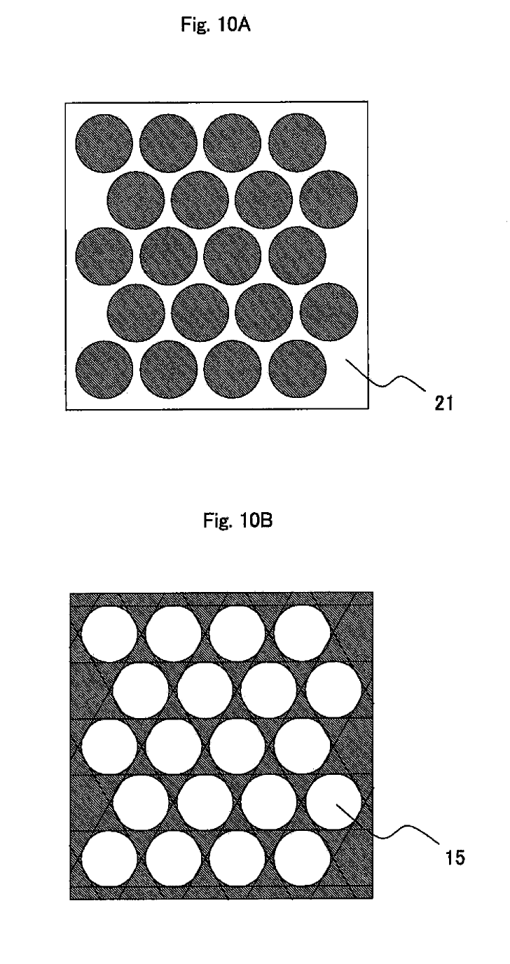

The chamfered portions 31 of the transparent substrate 15 shown in FIG. 9A are obtained by etching the corner portions of the transparent substrate. 15. This is shown in FIG. 10. First, as shown in FIG. 10A, a given patterned photoresist is applied onto the large-sized parallel planar substrate 21. The shaded portions in the drawing are portions coated with the photoresist. Thereafter, the large-sized parallel planar substrate 21 is etched, and then the photoresist is washed out. The shaded portions shown in FIG. 10B are the etched portions. Next, as shown by the solid lines in FIG. 10B, the parallel planar substrate 21 is segmentalized into a plurality of transparent substrates 15. As a segmentalizing method, a cutting work such as dicing is appropriate.

Herein, the pattern of the photoresist shown in FIG. 10A is designed such that the resist is not applied onto the portions corresponding to the corners of the transparent substrates 15 to be obtained by the process shown in FIG. 10B, and the chamfered portions 31 are formed onto the corner portions of the transparent substrates 15 by etching. A favorable etching depth is to be comparable with a radius of curvature of the rounded plane area at the bottom surface of the holder 8, which is desirably about several ten μm.

The shapes of the chamfered portions 31 of the transparent substrates 15 shown in FIGS. 10B and 10C are obtained by a cutting work such as dicing. By forming the chamfered portions 31 simultaneously with the process of segmentalizing the parallel planar substrate 21 with a cutting work, the chamfered portions 31 can be formed simply and economically.

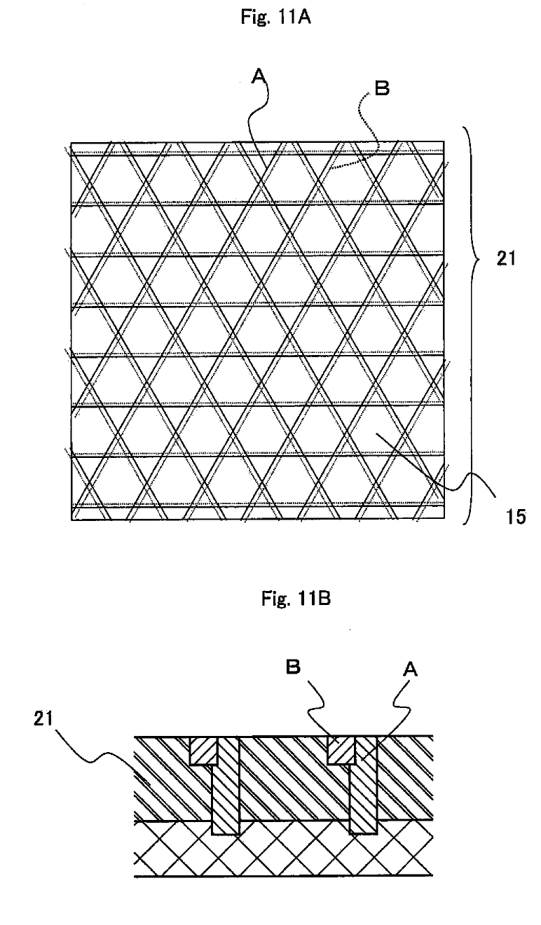

FIG. 11A shows a process example of the transparent substrates 15 shown in FIG. 9B. FIG. 11B shows a cross-sectional shape of the processed portion. Herein, cutting lines A indicate cutting lines for segmentalizing the large-sized parallel planar substrate 21 into pieces, and cutting lines B shown by dotted lines indicate cutting lines for forming the chamfered portions 31 onto the transparent substrate 15. The cutting depths of the cutting lines A and B are respectively different. The depth of the cutting lines A are deep enough to the thickness of the parallel planar substrate 21, then the cutting lines A segmentalize the transparent substrate 15 into pieces. On the other hand, the depth of the cutting lines B is several ten microns from the surface, then the cutting lines B form grooves with shallower depth than the thickness of the parallel planar substrate 21. The cutting lines B are formed along the cutting lines A so that the cutting lines B are in parallel with the cutting lines A and partially overlap with the cutting lines A in the width direction of the cutting lines A. In the transparent substrate 15 after the segmentalization, the cutting lines B are disposed on one of two adjacent sides and are arranged alternately. Thereby, the chamfered portions 31 are formed onto the corner portions and along the sides of the transparent substrates 15.

The cutting lines A and B may be processed with a same dicing blade, so as to shift a position into which the dicing blade is inserted and change the cutting depth.

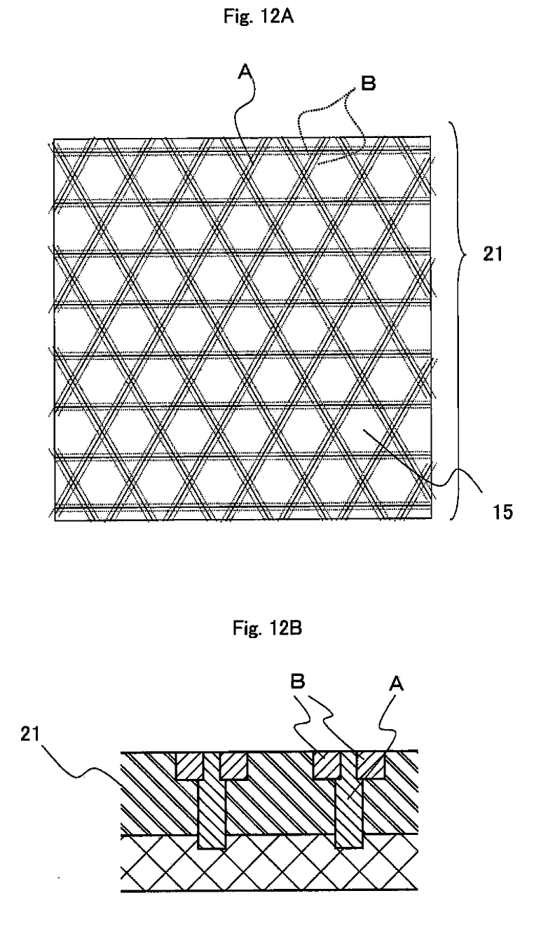

FIG. 12A shows a process example of the transparent substrates 15 shown in FIG. 9C. In the same manner as in FIG. 11, the cutting lines A indicate cutting lines for segmentalizing the large-sized parallel planar substrate 21 into pieces, and the cutting lines B indicate cutting lines for forming the chamfered portions 31 onto the transparent substrate. The cutting lines B are formed along the cutting lines A so that the cutting lines B are in parallel with the cutting lines A and partially overlap with the both sides of the cutting lines A, and in the transparent substrates 15 segmentalized into pieces, the cutting lines B which will be the chamfered portions 31 are disposed on its entire circumference. Thereby, the chamfered portions 31 are formed onto the entire circumference of the transparent substrates 15.

A width of the cutting line is almost the same as a width of the processing blade used for cutting. The widths of cutting lines A and B in FIGS. 10 and 11 are the same, but may be different from each other. In particular, FIG. 11 shows the cutting lines B formed by two processes. However, the cutting lines B may be formed by one process by use of a blade having a width wider than a width of a blade for the cutting lines A.

However, since an additional process of changing the blades during a cutting step such as dicing is needed if the plural blades having the different widths are used, it is easier and desirable to shift the blade which can forma cutting line with a constant width. Further, the shape of transparent substrates 15 shown in FIG. 9B is more preferable than the shape shown in FIG. 9C in the light of less number of processes for forming the chamfered portions 31 onto the corner portions of the transparent substrate 15.

As described above, in accordance with the optical receptacle 1 according to the one embodiment of the present invention, the chamfered portions 31 are formed onto the corner portions of the transparent substrate 15, thereby the transparent substrate 15 will not be into contact with the chamfered plane area or rounded plane area 29 even when the chamfered plane area or rounded plane area 29 is created on the outer circumferential portion of the bottom surface 20a, which makes it possible to provide the transparent substrate 15 which causes little chips by a vibration and an impact, and as a result, to provide the short-type optical receptacle 1 with mechanical endurance. Further, it is possible to bring the transparent substrate 15 into contact on its entire circumference with the bottom surface 20a, as a result, the transparent substrate 15 is disposed in parallel with the bottom surface 20a.

The example of the above-described embodiment shows the example in which the chamfered portions 31 are formed onto the surface on the side of the transparent substrate 15 contacting the holder 8. However, the chamfered portions 31 may be formed onto the surface on the side of the transparent substrate 15 contacting the sleeve 9 as well. In this case, it is possible to increase the mechanical endurance to a crash against the sleeve 9.

Other various embodiments relating to the configuration between the transparent substrate 15 and the case 5 (or the holder 8) will be hereinafter shown.

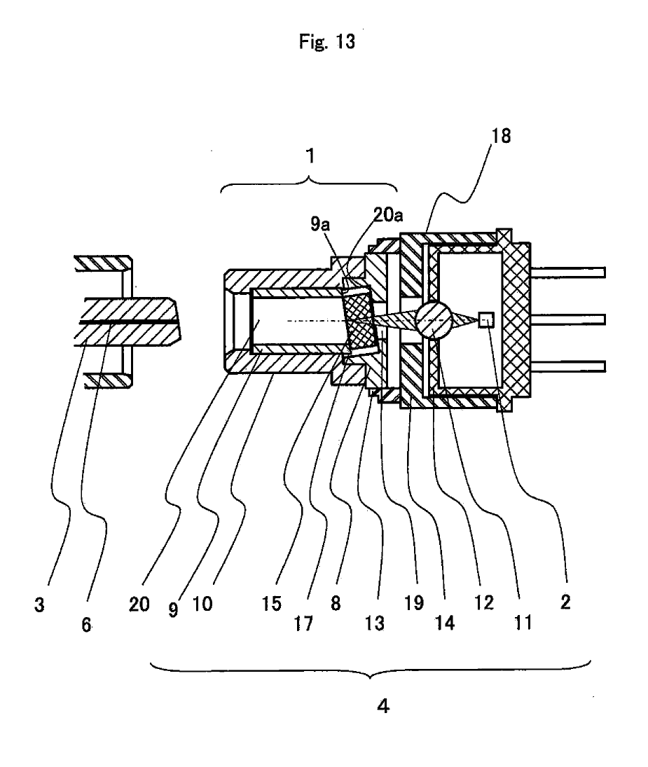

FIG. 13 shows an example of an embodiment of the optical receptacle 1 in which the bottom surface 20a of the insertion hole 20 is inclined to a plane perpendicular to the axis of the insertion hole 20. Since the bottom surface 20a is formed into an inclined surface, the surface of the transparent substrate 15 in contact with the bottom surface 20a is formed into an inclined surface to an optical axis parallel to the axis of the insertion hole 20. Therefore, A light signal emitted from the photon-electron or electron-photon conversion element 2 and reflected by the surface of the transparent substrate 15 will not become an incident light into the photon-electron or electron-photon conversion element 2 as a reflected returning light.

In this case, the rear edge face 9a of the sleeve 9 is formed into an inclined surface along the angle of inclination of the bottom surface 20a. Further, the front edge face of the plug ferrule 3 as well is subjected to an angled PC process along the angle of inclination. Thereby, it is possible to have a good contact with the transparent substrate 15.

In this case, it is preferable to provide a marking 18 indicating the direction of inclination of the bottom surface 20a on the outer side of the optical receptacle 1 or the optical module 4. When the angled PC plug ferrule 3 is inserted so as to match the direction of inclination, it is possible to easily make a PC connection between the front end of the optical fiber 6 and the transparent substrate 15.

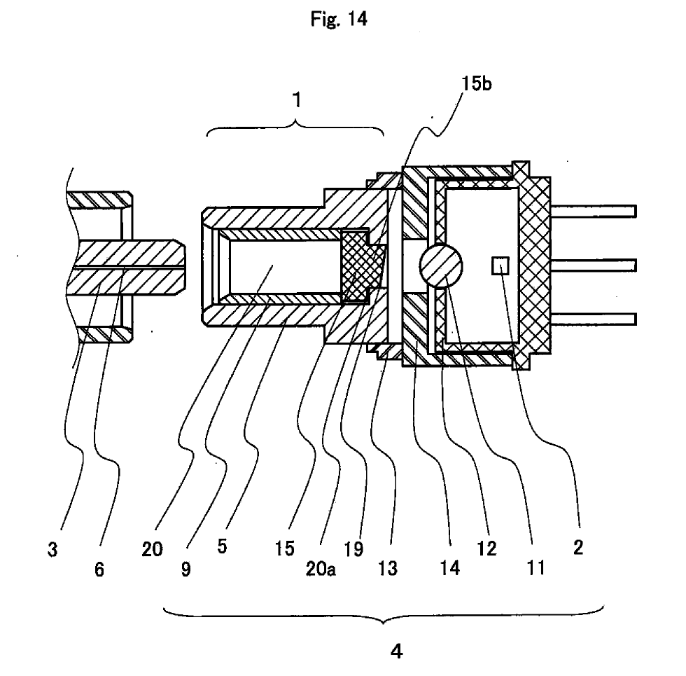

FIG. 14 shows an example in which a transparent convex portion 15b is formed on the one surface of the transparent substrate 15 in place of the refractive index matching agent 21 shown in FIG. 1, and the transparent substrate 15 is disposed so as to bring the convex portion 15b inserted into the through hole 19. In such an embodiment, since the through hole 19 is filled with the convex portion 15b having the same refractive index as the transparent substrate 15, it is possible to reduce the reflection of light due to a refractive index difference. Further, when the surface of the convex portion 15b is formed into a slope face shape inclined to the plane perpendicular to the axial direction of the through hole 19, it is possible to restrain light transmitted toward the through hole 19 from the photon-electron or electron-photon conversion element 2, such as a light-emitting element, being reflected by the surface of the convex portion 15b, to return to the photon-electron or electron-photon conversion element 2 as a returning light.

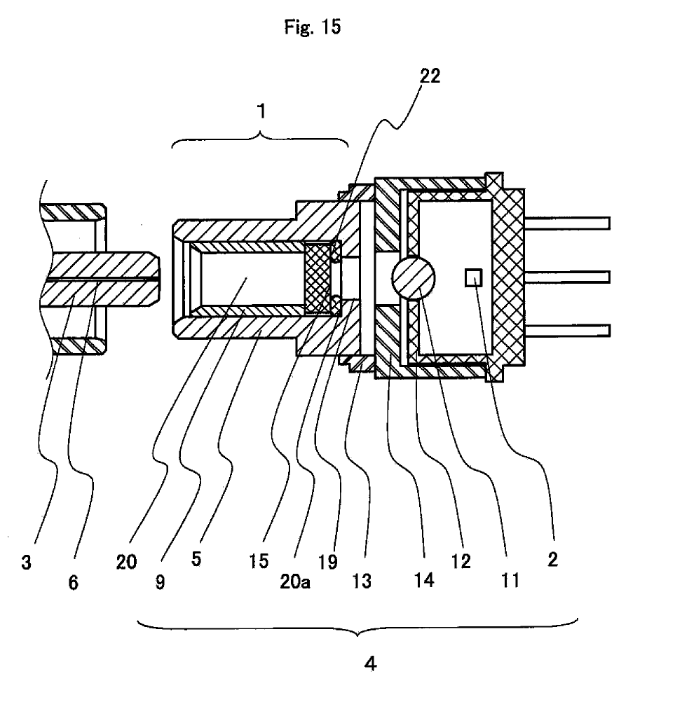

FIG. 15 shows an example of an embodiment of the optical receptacle 1 in which an elastic member 22 is further provided, so as to be disposed between the transparent substrate 15 and the bottom surface 20a of the insertion hole 20 of the case 5.

In this case, the both surfaces of the elastic member 22 are disposed so as to respectively contact the transparent substrate 15 and the bottom surface 20a at predetermined pressures, and are disposed so as to be sandwiched by the transparent substrate 15 and the bottom surface 20a. When the elastic member 22 is disposed between the transparent substrate 15 and the bottom surface 20a, it is easy to bring the front edge face of the plug ferrule 3, i.e., the front end of the optical fiber 6 and the transparent substrate 15 into good contact with each other with no influence thereon by a deviation from flatness or the like of the transparent substrate 15, and therefore, it is possible to prevent reflection or loss of light at the connecting point.

The elastic member 22 may be formed of a resin or a spring. For example, a resin plate having elasticity formed of silicone resins, urethane resins, acrylic resins, fluororesins, or the like may be used. Or, a coil spring or a plate spring made of metal or resin, or the like may be used as the elastic member 22.

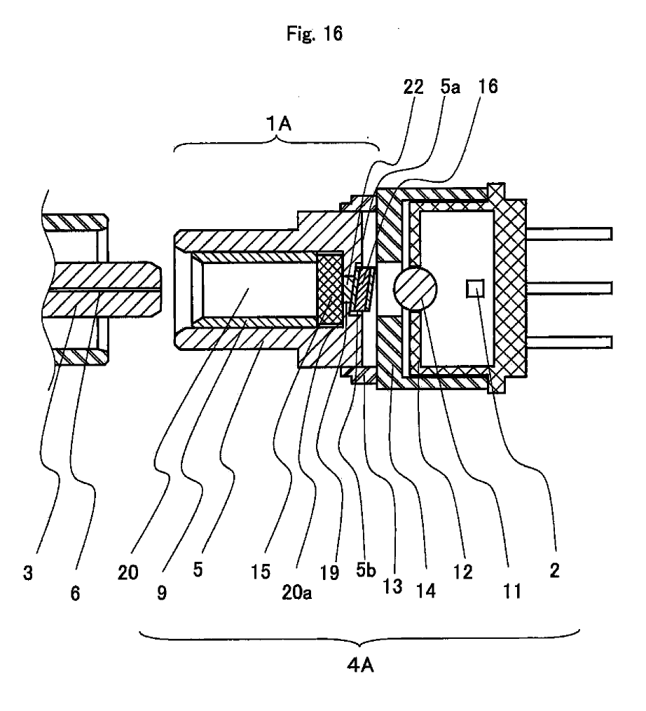

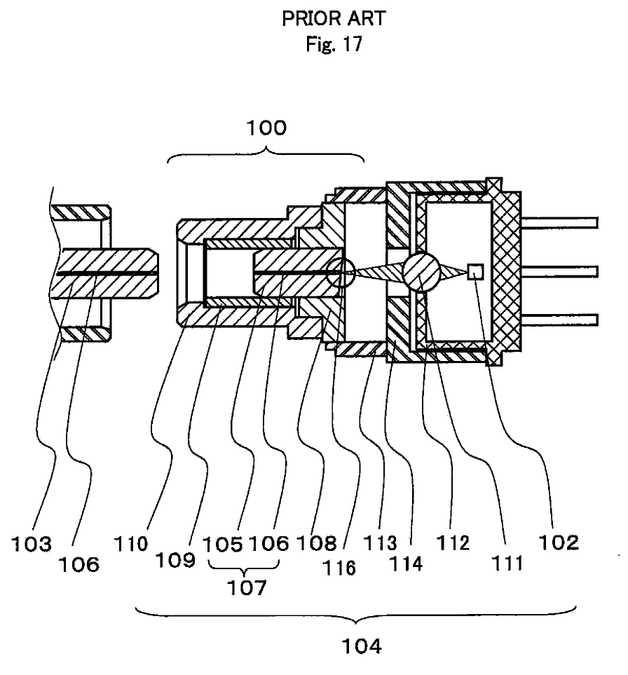

FIG. 16 is a cross-sectional view showing an example of one embodiment of the optical receptacle 1 in which an optical isolator element 16 is disposed on the one edge face 5a on the outer side of the case 5 of the optical receptacle 1. The optical receptacle 1 is different from the above-described respective optical receptacles 1 in the point that the optical isolator is further provided in the optical receptacle 1, and the other configurations are the same.

The optical isolator is composed of the optical isolator element 16 and a cylindrical magnet surrounding the optical isolator element 16, that inhibits passage of a reflected returning light returned from the side of the plug ferrule 3. The optical isolator is disposed such that a Faraday rotator composing the optical isolator element 16 is located inside the cylindrical magnet.

The optical isolator element 16 is disposed so as to block the opening of the through hole 19 open in the one edge face 5a of the case 5 on the opposite side of the insertion hole 20. Further, in the optical receptacle 1, the inside of the through hole 19 is filled with the refractive index matching agent 21. The refractive index matching agent 21 has a refraction refractive index matched to the refractive index of the transparent substrate 15 and the optical isolator element 16, which reduces refraction and reflection of light between the transparent substrate 15 and the optical isolator element 16.

It is preferable that, as shown in FIG. 16, a counterbore portion 5b is provided on the one edge face 5a of the case 5, in which the optical isolator element 16 is disposed. It is possible to accurately dispose the optical isolator element 16 by positioning the optical isolator element 16 in the counterbore portion 5b. Further, it is preferable that, as shown in FIG. 16, the counterbore portion 5b is inclined to the plane perpendicular to the optical axis, to incline the optical isolator element 16. It is preferable that the counterbore portion 5b is inclined at, for example, 4 to 11 degrees to the plane perpendicular to the optical axis.

The following materials may be used for the respective parts of the optical receptacle 1.

In the respective embodiments of the optical receptacle 1, in the case where the optical receptacle 1 is used for the optical module 4, in many cases, the optical receptacle 1 is welded to a case in which the photon-electron or electron-photon conversion element 2 (a light-emitting element or a light-receiving element) which is mounted in the optical module 4 is accommodated. Therefore, a weldable material such as stainless steel, copper, iron, or nickel is preferably used for the case 5 or the holder 8. Among such materials, stainless steel is desirable from the standpoint of resistance to corrosion and weldability. Further, considering adhesiveness with solder, gold plating or the like may be applied onto the outer surface of the case 5 or the holder 8.

In the case where the through hole 19 formed in the case 5 or the holder 8 need to be sealed in an airtight manner, it is possible to bring the transparent member 15 to adhere to the case 5 or the holder 8 with an organic adhesive such as epoxy resin, low-melting glass, or the like, to hermetically seal them. Since the hermetically-sealing is the purpose, for example, the outer circumferential surface of the transparent member 15 and the inner circumferential surface of the insertion hole 20 may be adhere to one another.

As the transparent member 15, an inorganic material such as glass, quartz, or sapphire, or a resin material such as an acrylic resin, a polymethyl methacrylate (PMMA) resin, a polycarbonate resin, or a polyolefin resin is given as an example. However, any material which is light-transmissive is not limited thereto. In particular, glass is preferable because of inexpensiveness and durability, and even when the plug ferrule 3 is repeatedly brought into contact, it keeps durable.

As the sleeve 9, zirconia ceramics, alumina ceramics, copper, or the like is used. It is preferable that a zirconia ceramic material is used from the standpoint of abrasion resistance. In addition, considering the insertability, it is desirable that the surface roughness of the inside diameter of the sleeve 9 has an arithmetic average roughness Ra=0.2 μm or less. It is desirable that a tolerance between the outside diameter of the plug ferrule 3 and the inside diameter of the sleeve 9 is 1 μm or less. With this configuration, the position of the optical fiber 6 accommodated in the plug ferrule 3 is disposed at a constant position even when the plug ferrule 3 is repeatedly inserted and pulled out, which leads to a stable optical connection.

The refractive index matching agent 21 may be any material having a refractive index comparable with that of the transparent substrate 15. For example, acrylic resins, epoxy resins, vinyl resins, ethylene resins, silicone resins, urethane resins, polyamide resins, fluororesins, polybutadiene resins, polycarbonate resins, or the like may be used. Among these materials, acrylic resins and epoxy resins are preferable from the standpoint of humidity resistance, heat resistance, peeling resistance, and impact resistance. In addition, when a refractive index difference between the refractive index matching agent 21 and the transparent substrate 15 is 0.1 or less, it is possible to sufficiently reduce reflection of light due to a refractive index difference.

Next, the optical module 4 according to an embodiment of the present invention has any one of the above-described optical receptacles 1 as shown as typical examples in FIGS. 2, 13, 14, 15, and 16. The optical module 4 is configured such that, for example, the package 12 in which the photon-electron or electron-photon conversion element 2 and a lens 12 are accommodated is joined to the outer side of the rear end part of the holder 8 via spacers 13 and 14. Then, the optical fiber 6 and the photon-electron or electron-photon conversion element 2 are optically coupled via the transparent member 15 and the through hole 19 by inserting the plug ferrule 3 into the insertion hole 20. In addition, the lens 11 disposed between the photon-electron or electron-photon conversion element 2 and the transparent substrate 15 is installed so as to focus on the core front end part of the optical fiber 6 brought into contact with the transparent substrate 15.

In many cases, the optical receptacle 1, the spacers 13 and 14, and the package 12 are joined together by welding such as YAG laser welding. Therefore, as materials composing the package 12 and the spacers 13 and 14, the same material as that of the holder 8 is preferable.

In the case where the optical module 4 is assembled with an adjustment to get a maximum optical coupling to the optical fiber 6, an optical signal is focused to a spot size of about 10 μm in the vicinity of the front edge face of the optical fiber 6 after passing through the lens 12, the optical isolator element 16, and the like. In this case, its optical output may fluctuate even a slight positional fluctuation of the spot by several μm. Therefore, in some cases, in the optical module 4, its focal point may be shifted slightly back and forth to enlarge the spot size in the vicinity of the front edge face of the optical fiber 6 on purpose so that about 40% to 60% of the light output from the photon-electron or electron-photon conversion element 2 is optically coupled on the optical fiber 6.

Since a reflected light generated on an optical surface of the transparent member 15 or the optical isolator element 16 on the side of the photon-electron or electron-photon conversion element 2 is returned as a returning light to the photon-electron or electron-photon conversion element 2 via the lens 11, it is preferable that an anti-reflection coating (not shown) is applied onto the optical surface.

In this way, according to the receptacle type optical module 4 of the embodiment of the present invention, the inserted plug ferrule 3 is brought into contact with the transparent substrate 15, and the inserted ferrule 3 is placed at the constant position in the insertion direction. The transparent substrate 15 is supported by the case 5 or the holder 8, and the transparent substrate 15 is placed at a constant position by inserting the plug ferrule 3, which provides the optical module 4 having the excellent optical characteristics. The excellent optical module 4 having good reliability can be provided even in the case where the plug ferrule 3 is repeatedly inserted and pulled out, or in a high-temperature and humidity environment.

### DESCRIPTION OF REFERENCE NUMERALS

1: Optical receptacle
2: Photon-electron or electron-photon conversion element
3: Plug ferrule
4: Optical module
5: Case
6: Optical fiber
8: Holder
9: Sleeve
10: Shell
11: Lens
12: Package
13, 14: Spacer
15: Transparent substrate
17: Hole
18: Marking
19: Through hole
20: Insertion hole
20a: Bottom surface
31: Chamfered portions

What is claimed is:

1. An optical receptacle to which a plug ferrule for holding an optical fiber is connected, the optical receptacle comprising:
a case forming an outer shell, the case having an insertion hole which has a bottom surface at one end thereof and into which the plug ferrule is to be inserted; and
a transparent substrate disposed on the bottom surface,
wherein the case has a through hole formed so as to penetrate from the bottom surface of the insertion hole to an end face of the case and communicated with the insertion hole, the through hole having a diameter smaller than that of the insertion hole, and
wherein the transparent substrate is in contact with the bottom surface so as to cover an opening of the through hole which opens in the bottom surface.

2. The optical receptacle according to claim 1, further comprising a sleeve to be inserted into the insertion hole,
wherein one edge face of the sleeve is in contact with the transparent substrate.

3. The optical receptacle according to claim 1, wherein the transparent substrate has a polygonal shape.

4. The optical receptacle according to claim 3, wherein corner portions of a contacting surface of the transparent substrate which contacts the bottom surface are chamfered to provide gaps between the corner portions and an inner surface of the insertion hole.

5. The optical receptacle according to claim 3, wherein one of two adjacent sides of a contacting surface of the transparent substrate which contacts the bottom surface is chamfered, the chamfered side and non-chamfered side being arranged alternately.

6. The optical receptacle according to claim 3, wherein an entire circumference of a contacting surface of the transparent substrate which contacts the bottom surface is chamfered.

7. The optical receptacle according to claim 3, wherein the opposite sides of the polygonal shape of the transparent substrate are in parallel with each other.

8. The optical receptacle according to claim 1, wherein the bottom surface is inclined to a plane perpendicular to an axis of the insertion hole.

9. The optical receptacle according to claim 1, wherein the transparent substrate has a transparent convex portion on its one surface, the convex portion being disposed so as to fit into to be inserted in the through hole.

10. The optical receptacle according to claim 1, wherein the transparent substrate is formed of at least one of glass and sapphire.

11. The optical receptacle according to claim 1, further comprising an elastic member to be disposed between the transparent substrate and the bottom surface of the insertion hole.

12. The optical receptacle according to claim 11, wherein the elastic member is formed of resin or spring.

13. The optical receptacle according to claim 1, further comprising an optical isolator element to be disposed on the one edge face of the case so as to cover the opening of the through hole which opens in the one edge face,
wherein the inside of the through hole is filled with a refractive index matching agent.

14. The optical receptacle according to claim 13, wherein the refractive index matching agent contains at least one of acrylic resins and epoxy resin.

15. An optical module comprising:
the optical receptacle according to claim 1;
an optical element for receiving or emitting a light passing through the through hole; and
a cylindrical body joined to the case of the optical receptacle to accommodate the optical element.
